(19) United States
(12) Patent Application Publication
(10) Pub. No.: US 2005/0250356 A1
(43) Pub. Date: Nov. 10, 2005

(54) Press-fit terminal and circuit board module using the same

(75) Inventors: Kaoru Matsumura, Shizuoka (JP); Shigeru Tanaka, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/123,023

(22) Filed: May 6, 2005

(30) Foreign Application Priority Data
May 10, 2004 (JP) 2004-139417
Dec. 8, 2004 (JP) 2004-355045

(51) Int. Cl. H01R 13/42

(52) U.S. Cl. 439/82

(57) ABSTRACT

A press-fit terminal includes a pair of the resilient contacts being swelled outward, and having a deformation space into which the resilient contacts are deformed. The press-fit terminal is electrically connected to a conductive inner wall of a through-hole on a circuit board by pressing the press-fit terminal into the through-hole. The press-fit terminal includes abutting portions on each inner wall of the pair of the resilient contacts. When the abutting portions abut on each other, the abutting portions regulate deformation of the resilient contacts in a narrowing direction to narrow the deformation space. Then inclined walls formed on the abutting portions induce the resilient contacts to slide on the inclined walls in a direction to separate the resilient contacts from each other.

### BACKGROUND OF THE INVENTION

The priority application claims priority of Japanese Patent Application No. 2004-355045, which is hereby incorporated by reference.

### FIELD OF THE INVENTION

This invention relates to a press-fit terminal for being pressed into a through-hole and electrically contacting a conductive member formed on an inner wall of the through hole, and a circuit board using the press-fit terminal.

### DESCRIPTION OF THE RELATED ART

Generally, a through-hole into which a press-fit terminal is inserted is formed on a printed circuit board. The press-fit terminal includes a press-fit portion to be mechanically held in the through-hole. One embodiment of the press-fit terminal is disclosed Japanese Patent Application Document JP-A, H05-114427 (Page 2, and FIG. 5), and shown in FIG. 14.

The press-fit terminal 50 is formed by press molding and made of such as copper-alloy, aluminum-alloy and the like. The press-fit portion 52 is positioned between an introducing portion and an electrically contact portion at a rear end of the press-fit terminal. The press-fit portion 52 includes a thin portion 52a in the middle thereof. Thereby, when the press-fit terminal 50 is pressed into the through-hole 55a, each side of the press-fit portion 52 is resiliently deformed about the thin portion 52a.

However, there is a problem that an amount of deformation of the press-fit portion 52 is small. For solving the problem, another embodiment of the press-fit terminal 60 is disclosed in Japanese Patent Application Document JP-A, 2003-283093 (Page 3 to 4, and FIG. 1) and shown in FIG. 15.

As shown in FIG. 15, a press-fit terminal 60 includes a pair of the resilient contacts 63 as the press-fit portion 63. The resilient contacts 63 are formed on both sides of a slit as the deformation space 62, and allowed to be resiliently deformed in a direction of narrowing the deformation space 62. As an introducing portion 61, a distal end of the press-fit terminal 60 continued to the resilient contacts 63 is tapered in order to be pressed into a through-hole 65a of a circuit board 65 smoothly.

As pressed into the through-hole 65a, the pair of the resilient contacts 63 is deformed against an inner wall of the through-hole 65a. Then, the resilient contacts 63 are located at a predetermined depth, and held mechanically by their own recovery force against the deformation.

Since the amount of deformation of the resilient contacts 63 is large, the press-fit terminal 60 is allowed to be press-fitted with low press-fit force. However, since the resilient contacts 63 is formed thin, there is a problem that terminal-holding force to hold the press-fit terminal 60 in the through-hole 65a based on the recovery force of the resilient contacts 63 is weak.

On the other hand, if the resilient contacts 63 is formed thick to improve the recovery force thereof, the terminal-holding force is improved. However, high press-fit force is needed for pressing the press-fit terminal 60 into the through-hole 65a. Resultingly, there are problems such as a seepage of resin from the circuit board 65, damage of the circuit board 65 to lose conductivity by partial detachment thereof, a buckling of the press-fit terminal 60, and the like.

Further, if the recovery force of the resilient contacts 63 is large, the terminal-holding force is easy to be varied by finished dimensions of the through-hole 65a and the press-fit terminal 60. Thus, contact reliability of the press-fit terminal assembly is reduced.

Accordingly, it is an object of the present invention to provide a press-fit terminal and a circuit board module using the press-fit terminal to allow the terminal holding force increase, the press-fit force to reduce, and the electrical contact reliability to increase.

### SUMMARY OF THE INVENTION

In order to attain the object, according to the present invention, there is provided a press-fit terminal to be pressed into a through-hole of a terminal receiving member for making electrical contact with an inner wall of the through-hole, said press-fit terminal including:
a pair of resilient contacts having inner walls on which abutting portions are formed respectively; and
a deformation space into which the resilient contacts are deformed,
the resilient contacts are resiliently deformed in one direction of narrowing the deformation space for abutting and also in a direction different from the direction of abutting,
whereby the resilient contacts are pressingly contacted with the inner wall of the through-hole by recovery force of the deformed resilient contacts acting in said two directions.

According to the above, when being pressed into the through-hole, the pair of the resilient contacts separated at both sides of the deformation space is resiliently deformed in the direction to make the abutting portions abut on each other, and narrow the deformation space. Then, the abutting portions of the resilient contacts abut on each other, and the deformation in the direction of abutting is regulated. Then, when the resilient contacts are further pressed into the through-hole, the pair of the resilient contacts is deformed in a direction different from the direction of abutting.

According to the above, the pair of the resilient contacts can be resiliently deformed in two directions. Therefore, in comparison with the resilient contacts deformed in only one of direction, a total amount of deformation of the resilient contacts deformed in two directions can be large. Therefore, even if the pair of the resilient contacts is formed thick for improving terminal holding force, and resultingly the deformation space becomes narrower, the pair of the resilient contacts is pressed into the through-hole without improving press-fit force. Further, the pair of the resilient contacts firmly contacts with the inner wall of the through-hole, with a sum of recovery force in two directions. Therefore, electric contact reliability is improved. Here, the press-fit force is defined as pressing force to press the press-fit terminal in an axial direction thereof. The terminal holding force is defined as holding force to hold the press-fit terminal with external force received from the inner wall of the through-hole.

Preferably, each of the abutting portions includes an inclined wall by which each of the resilient contacts is caused relative displacement in a direction different from the direction of abutting.

According to the above, abutting portions abutting on the pair of the resilient contacts regulates the deformation of the resilient contacts in the direction of abutting. Then, the pair of the resilient contacts is slid on the inclined walls as being resiliently deformed in the direction different from the direction of abutting. Thereby, the inner wall of the through-hole receives the recovery force in two directions.

Preferably, one end of the resilient contacts formed substantially into a V-shape is disposed at a portion where acts as a supporting point for resilient deformation in the direction different from the direction of abutting.

According to the above, abutting portions abutting on the pair of the resilient contacts regulates the deformation of the resilient contacts in the direction of abutting. Then, the pair of the resilient contacts is twisted about the abutting portions abutting each other in narrowing directions to narrow an aperture angle between the V-shaped resilient contacts.

According to another aspect of the present invention, there is provided a circuit board module including:
the press-fit terminal as described above; and
a circuit board having a through-hole for press-fitting and holding the pair of the resilient contacts.

According to the above, even if recovery force of the pair of the resilient contacts is large, an amount of deformation of the pair of the resilient contacts can be large. Therefore, terminal-holding force of the pair of the resilient contacts can be large, and press-fit force can be small.

Preferably, a connector housing for holding the press-fit terminal is mounted on the circuit board.

According to the above, a plurality of press-fit terminals are collectively held in the connector housing. Thereby, the slim press-fit terminals are reinforced with the connector housing, and prevented from being short-circuited each other. Further, mounting the connector housing holding the press-fit terminals on the circuit board improves connection workability between the circuit board and the press-fit terminals.

The above and other objects, features, and advantages of the present invention will be better understood when taken in connection with the accompanying drawings and description.

### BRIEF DESCRIPTION OF THE DRAWINGS

FIG. 1 is a perspective view showing a first embodiment of a press-fit terminal according to the present invention;

FIG. 2 is a front view of the press-fit terminal shown in FIG. 1;

FIG. 3 is a sectional view taken on line A-A′ in FIG. 2;

FIG. 4 is a sectional view of a circuit board having a through-hole into which the press-fit terminal of FIG. 1 is pressed at a predetermined position;

FIG. 5 is a sectional view taken on line B-B′ in FIG. 4;

FIG. 6 is a perspective view showing a second embodiment of the press-fit terminal according to the present invention;

FIG. 7 is a front view of the press-fit terminal in FIG. 6;

FIG. 8 is a sectional view taken on line C-C′ in FIG. 7;

FIG. 9 is an enlarged view of a pair of the resilient contacts of the press-fit terminal in FIG. 6;

FIG. 10 is a sectional view of a circuit board having a through-hole into which the press-fit terminal of FIG. 6 is slightly pressed;

FIG. 11 is a sectional view taken on line D-D′ in FIG. 10;

FIG. 12 is a sectional view of a circuit board having a through-hole into which the press-fit terminal of FIG. 6 is pressed at a shallow position;

FIG. 13 is a sectional view taken on line E-E′ in FIG. 12;

FIG. 14A is an explanatory view of one embodiment of a conventional press-fit terminal before being pressed into a through hole;

FIG. 14B is an explanatory view of the conventional press-fit terminal shown in 14A after being pressed into a through hole; and

FIG. 15 is a sectional view showing another embodiment of the conventional press-fit terminal.

### DESCRIPTION OF THE PREFERRED EMBODIMENTS

### First Embodiment of the Present Invention

A first embodiment of a press-fit terminal according to the present invention will be described below with reference to FIGS. 1 to 5.

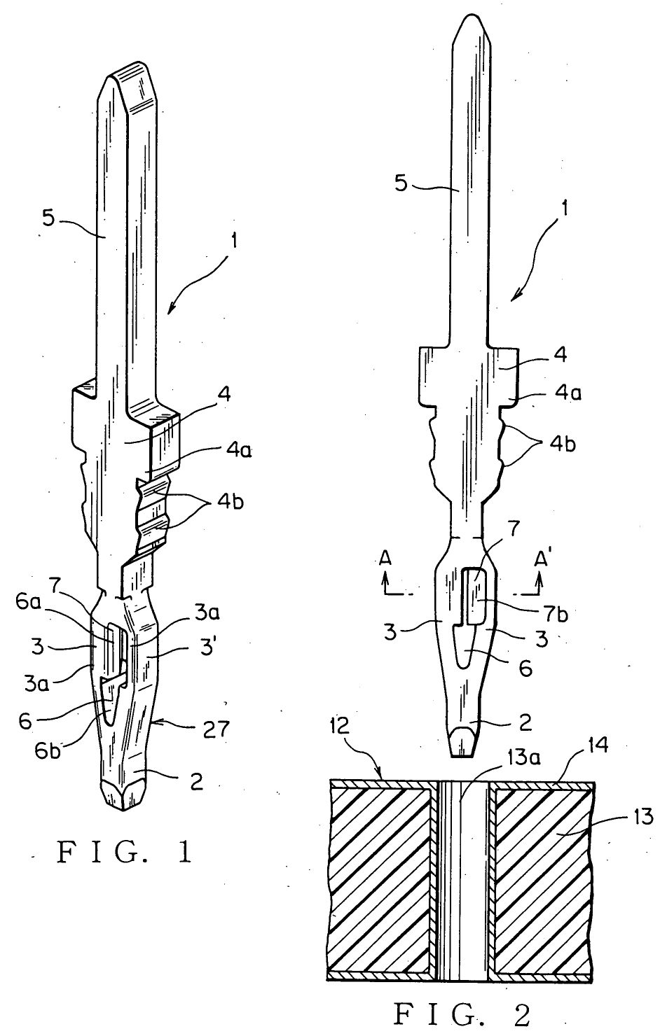

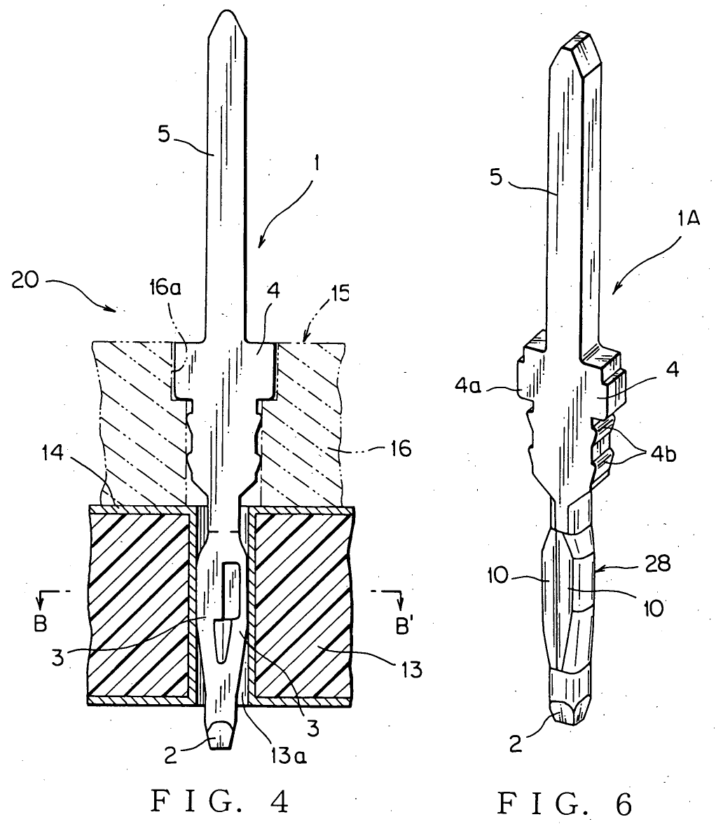

A press-fit terminal 1 of the first embodiment is formed in a strip shape by stamping a conductive substrate made of such as copper-alloy. The press-fit terminal 1 includes: an introducing portion 2 to be inserted into a through-hole 13a of a circuit board 12 (FIG. 2); a pair of resilient contacts 3 continued to the introducing portion 2 and being swelled; a substrate-press-fit portion 27 having the introducing portion 2 and the resilient contacts 3; a housing-press-fit portion 4 continued to the resilient contacts 3 to be pressed into a connector housing 16 (FIG. 4); and a tabular electric contact 5 continued to the housing-press-fit portion 4.

A direct mounting connector 15 includes the connector housing 16 made of resin, and a plurality of press-fit terminals 1 pressed into the connector housing 16. As shown in FIG. 4, a circuit board module 20 includes the circuit board 12 and the direct mounting connector 15 directly mounted on the circuit board 12.

As shown in FIG. 2, the circuit board 12 includes an isolating substrate 13 and a wiring conductor 14 formed in a circuit pattern on the isolating substrate 13. The isolating substrate 13 is made of organic material such as an epoxy resin, and includes a plurality of through-holes 13a made by a carbide drill having an ultra-small diameter or a laser. Each inner wall of the through-holes 13a is plated with conductive material such as copper foil for being electrically connected to the wiring conductor 14. When the pair of the resilient contacts 3 of the press-fit terminal 1 is pressed into the through-hole 13a, a printed circuit on the circuit board 12 is electrically connected to an outer circuit.

As shown in FIG. 2, the introducing portion 2 of the press-fit terminal 1 locates and guides the press-fit terminal 1 onto the through-hole 13a. The introducing portion 2 is formed smaller than an inner diameter of the through-hole 13a. Four corners of a top end of the introducing portion 2 are chamfered.

The pair of the resilient contacts 3 continued to the introducing portion 2 is formed larger than the through-hole 13a, supported at both ends thereof, facing to each other, and able to be resiliently deformed in a direction of narrowing a deformation space 6. Thereby the inner wall of the through-holes 13 is allowed to hold the pair of the resilient contacts 3.

As shown in FIG. 1, a straight portion 3a extends in the middle of each of the resilient contacts 3 in an axial direction of the press-fit terminal 1 for contacting the inner wall of the through-holes 13a. As shown in FIG. 5, since corners 21, 21′, 22, 22′ on an outer wall of the straight portion 3a are curved, the through-holes 13a and the press-fit terminal 1 are allowed to contact each other with large contact areas.

A lower side of the straight portion 3a is gradually inclined and smoothly continued to the introducing portion 2. Thereby, the resilient contacts 3 are smoothly pressed into the through-hole 13a without any catch. An upper side of the straight portion 3a is gradually inclined and smoothly continued to the housing-press-fit portion 4. Thus, the press-fit terminal 1 is prevented from being broken, or buckling when being pressed into the through-holes 13a.

As shown in FIG. 4, the housing-press-fit portion 4 is to be pressed into the connector housing 16 of the direct mounting connector 15. The housing-press-fit portion 4 includes a shoulder 4a for locating and a plurality of projections 4b formed below the shoulder 4a as slip stoppers by engaging an inner wall of a press-fit hole 16a. When the housing-press-fit portion 4 pressed into the press-fit hole 16a, the pair of the resilient contacts 3 is held in the through-holes 13a at a predetermined depth.

The tabular electric contact 5 is to be electrically connected to an electric contact of a female terminal of a not-shown mating connector for being connected to the direct mounting connector 15. When the electric contact 5 is connected to the electric contact of the mating terminal, the printed circuit on the circuit board 12 is electrically connected to the outer circuit.

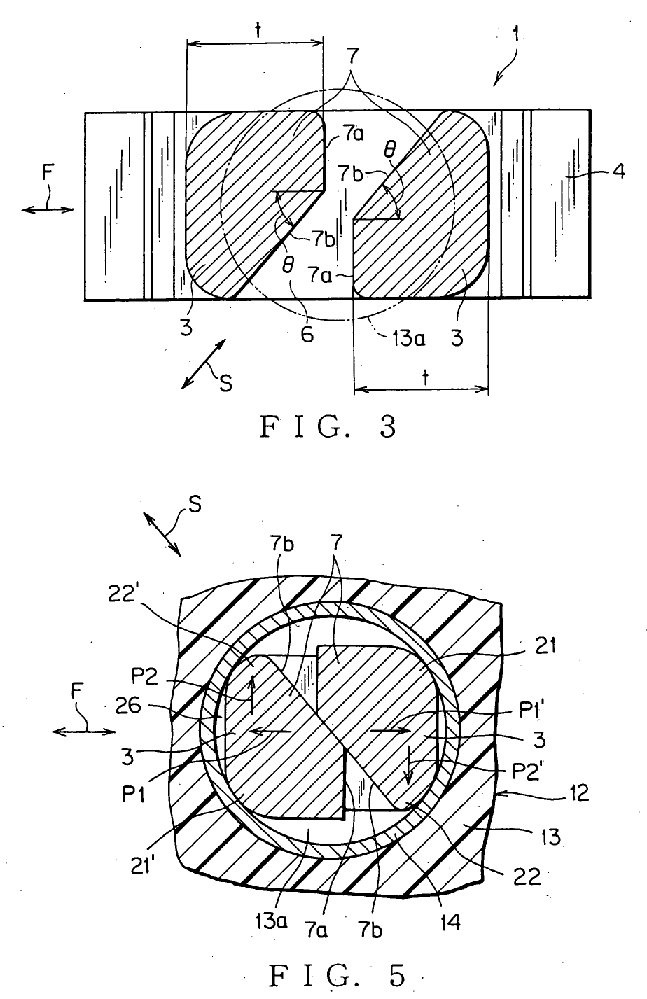

The pair of the resilient contacts 3 will be explained in detail with reference to FIG. 3. Abutting portions 7 are formed on inner walls of the resilient contacts 3 to regulate the resilient contacts 3 from being resiliently deformed in a facing direction F facing to each other, and induce the resilient contacts 3 to be resiliently deformed in an oblique direction S being oblique to the facing direction F.

As shown in FIG. 3, the abutting portions 7 include parallel walls 7a being parallel to each other, and inclined walls 7b being parallel to each other, and oblique to the parallel walls 7a. The inclined walls 7a are respectively continued to the parallel walls 7a. The recovery force of the resilient contacts 3 increases as thickness of the resilient contacts 3 increases. However, the parallel walls 7a, the inclined walls 7b, and thickness of the resilient contacts 3 are so designed that the resilient contacts 3 contact each other may be inserted into the through-hole 13a.

When the inclined walls 7b of the abutting portions 7 abutting on each other, the resilient deformations of the resilient contacts 3 in the facing direction F are regulated. Then, the resilient contacts 3 are deformed in both facing and oblique directions F and S simultaneously. A value of an inclination angle θ of the inclined walls 7b is designed optionally corresponding to a diameter of the through-holes 13a, sectional forms of the resilient contacts 3 and the like. In this embodiment, the inclination angle θ is set to 50 degrees. The small inclination angle θ of the inclined walls 7b makes the resilient contacts 3 easy to slide, while the large inclination angle 0 of the inclined walls 7b makes the resilient contacts 3 hard to slide.

FIG. 4 shows the pair of the resilient contacts 3 pressed into the through-holes 13a at a predetermined position. As the pair of the resilient contacts 3 is gradually pressed into the through-holes 13a from a top end of the pair of the resilient contacts 3, the pair of the resilient contacts 3 are bent about an upper and lower ends of the deformation space 6 in the facing direction F until the abutting portions 7 abutting on each other. When the abutting portions 7 abut on each other, the deformation of the resilient contacts 3 in the facing direction F is regulated. When being pressed further, the pair of the resilient contacts 3 is resiliently deformed along the inclined walls 7b of the abutting portions 7 in the oblique direction S. Thus, as shown in FIG. 15, the pair of the resilient contacts 3 is firmly held at the corners 21, 21′, 22, 22′ by the through-hole 13a under recovery force against both bending stress P1, P1′ in the facing direction F and shearing stress P2, P2′ in the oblique direction S.

The direct mounting connector 15 includes the connector housing 16 and a plurality of the press-fit terminals 1 pressed into the connector housing 16. When the direct mounting connector 15 is mounted on the circuit board 12, the press-fit terminals 1 are electrically connected to the circuit board 12, and the circuit board module 20 as an intermediate product is assembled.

Since the press-fit terminals 1 are held by the connector housing 16, the press-fit terminals 1 are reinforced with the connector housing 16, and prevented from being short-circuited with each other. Further, since the direct mounting connector 15 is mounted on the circuit board 12, connection workability between the press-fit terminals 1 and the circuit board 12 is improved.

According to the press-fit terminal 1 of the first embodiment of the present invention described above, since the abutting portions 7 having the inclined walls 7b are formed on the inner walls of the pair of the resilient contacts 3, the resilient bending deformation in the facing direction F is regulated, and the resilient shearing deformation in the oblique direction S along the inclined walls 7b is generated. Therefore, the total resilient deformation amount of the pair of the resilient contacts 3 of the press-fit terminal 1 is larger than the pair of the resilient contacts 63 of the conventional press-fit terminal being only bent to be resiliently deformed. Further, even if the resilient contacts 3 are formed thick for improving the recovery force, the press-fit terminal 1 can be pressed into the through-hole 13a with relatively low pressure.

Since the recovery force in two directions dispersively urge the inner wall of the through-hole 13a, the pair of the resilient contacts 3 is held in balance, and a variety in the terminal-holding forces caused by finished dimensions of the through-hole 13a and the press-fit terminal 1 is reduced.

### Second Embodiment of the Present Invention

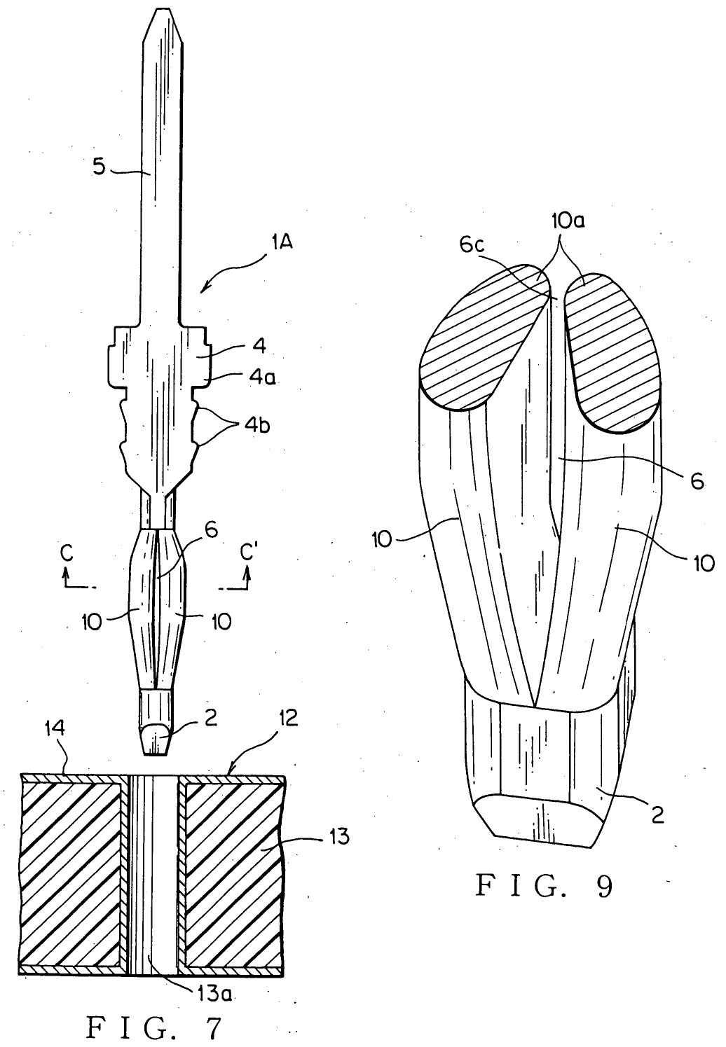

A second embodiment of a press-fit terminal according to the present invention will be described below with reference to FIGS. 6 to 13. In order to avoid repetitions, identical elements will be designated by identical reference numerals and only the differences existing in comparison with the first embodiment will be explained.

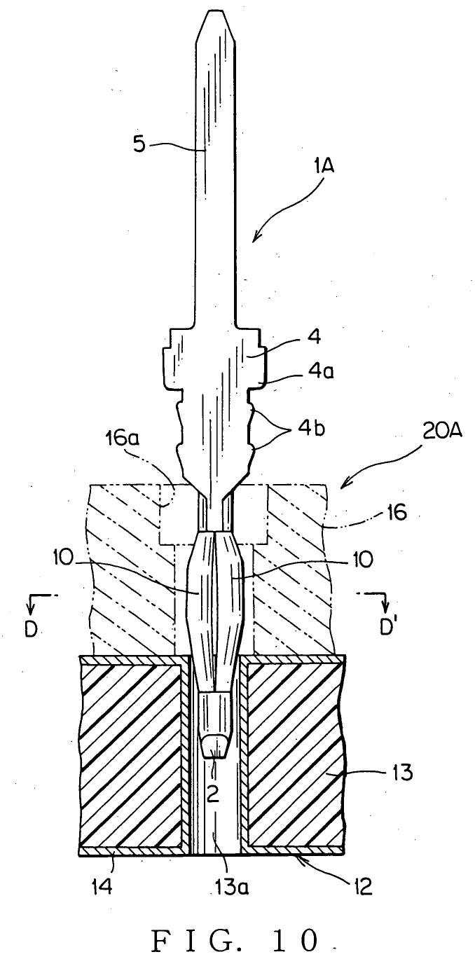

As shown in FIG. 9, a pair of resilient contacts 10 of a press-fit terminal 1A includes a substantially V section perpendicular to an axis of the press-fit terminal 1A. As shown in FIG. 6, a press-fit portion 28 of the press-fit terminal 1A includes an introducing portion 2 and the resilient contacts 10.

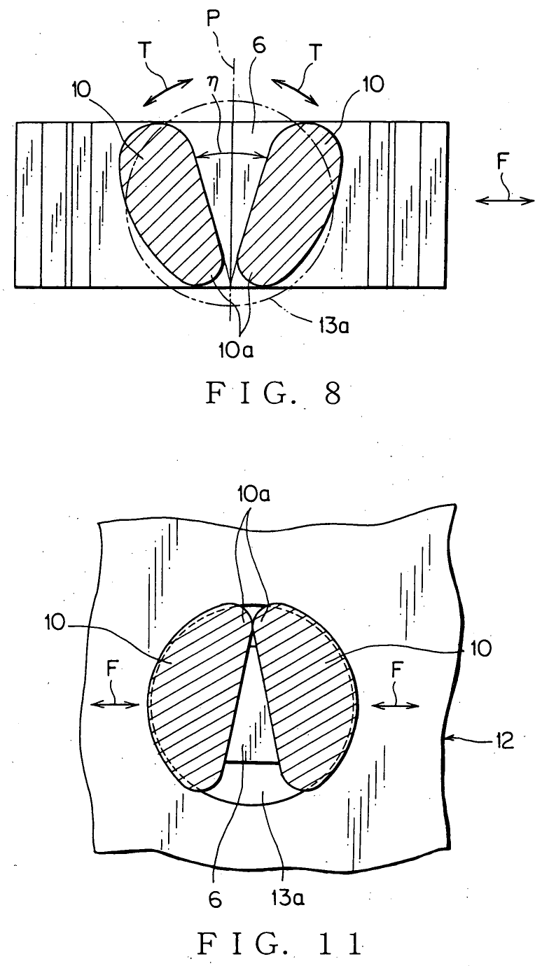

As shown in FIG. 9, each of the resilient contacts 10 has a substantially semi-circular section perpendicular to a longitudinal direction along a length of each resilient contact 10. As shown in FIG. 8, an aperture angle η is defined as an angle between inner flat walls of the resilient contacts 10. A value of the aperture angle η is optional, and set to 30 degrees in the second embodiment. The pair of the resilient contacts 10 are allowed to be resiliently deformed in a circumferential direction T to narrow the aperture angle η.

As shown in FIGS. 8 and 9, the pair of the resilient contacts 10 is separated on both sides of the deformation space 6 in unloaded condition, and has a line symmetry shape. The pair of the resilient contacts 10 respectively includes abutting portions 10a, on which the resilient contacts 10 are to abut each other, on inner walls thereof at the nearest position to an axis P of the line symmetry. A gap 6c exists between the abutting portions 10a in unloaded condition.

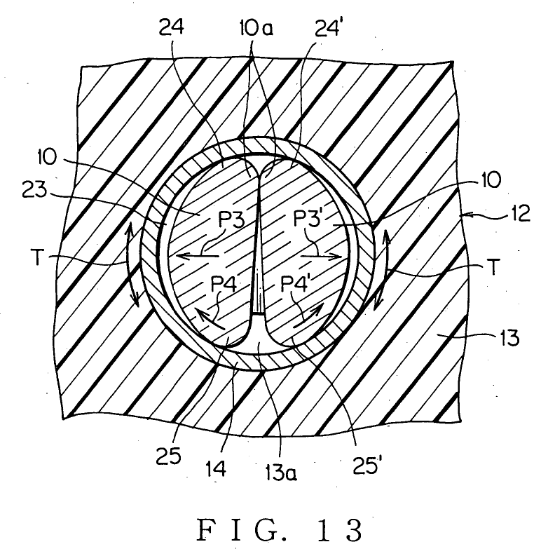

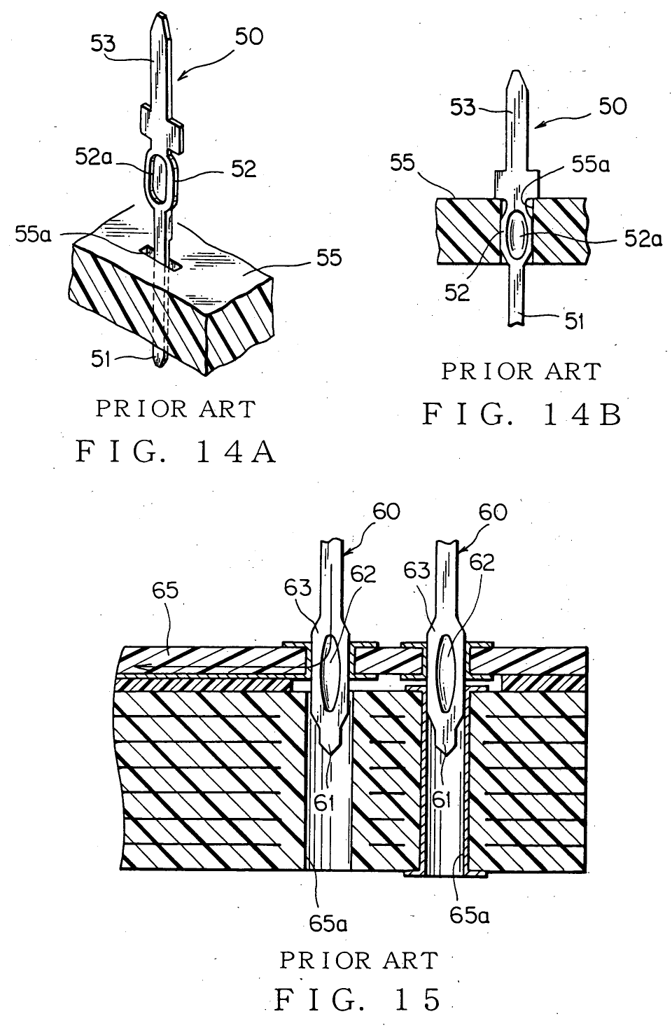

The abutting portions 10a are fulcrums to resiliently deform the pair of the resilient contacts 10 in the circumferential direction T shown in FIGS. 8 and 13. When the pair of the resilient contacts 10 is pressed into the through-hole 13a, the abutting portions 10a abut on each other and regulate a bending deformation in a facing direction F shown in FIGS. 8 and 12. Then, the pair of the resilient contacts 10 is resiliently deformed about the abutting portions 10a in the circumferential direction T to be narrowed along the inner wall of the through-holes 13a.

Each outer wall of the resilient contacts 10 has a smoothly curved surface. Therefore, the pair of the resilient contacts 10 slides on the inner wall of the through-hole 13a with a small frictional resistance, and contacts the inner wall of the through-hole 13a in large areas. As shown in FIG. 13, the pair of the resilient contacts 10 is so designed as to make gaps 23 between the outer walls of the resilient contacts 10 and the inner walls of the through-hole 13a when the resilient contacts 10 are pressed into the through-hole 13a.

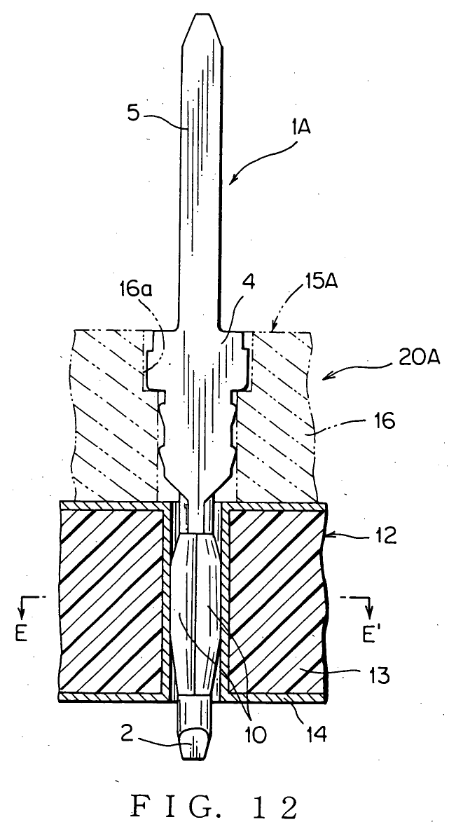

A deformation process of the pair of the resilient contacts 10 pressed into the through-hole 13a will be explained in detail with reference to FIGS. 10 to 13. FIG. 10 shows a state that the pair of the resilient contacts 10 contacts an opening edge of the through-hole 13a. As shown in FIG. 11, the pair of the resilient contacts 10 contacting the inner wall of the through-hole 13a is resiliently deformed in the facing direction F to narrow the deformation space 6. Then, the abutting portions 10a of the resilient contacts 10 abut on each other to regulate the resilient deformation in the facing direction F.

FIG. 12 shows the press-fit terminal 1A pressed into the through-hole 13a at a predetermined position. As shown in FIG. 13, the resilient contacts 10 are twisted about the abutting portions 10a in an opposite direction T, and resiliently deformed along the inner wall of the through-hole 13a. Namely, the pair of the resilient contacts 10 is twisted to be resiliently deformed in a direction of narrowing the aperture angle η in FIG. 8.

While the press-fit terminal 1A is pressed, the pair of the resilient contacts 10 is resiliently deformed as shifting contact points with the inner wall of the through-hole 13a. Thereby, recovery force is not centered on a specific position of the inner wall of the through-hole 13a. Therefore, the inner wall of the through-hole 13a is prevented from exfoliation damage.

As shown in FIG. 12, a direct mounting connector 15A includes the connector housing 16 and a plurality of press-fit terminals 1A pressed into the connector housing 16. A circuit board module 20A includes the circuit board 12 and the direct mounting connector 15A directly mounted on the circuit board 12.

According to the press-fit terminal 1A of the second embodiment, since the abutting portions 10a are formed on the inner walls of the pair of the resilient contacts 10, the bending deformation in the facing direction F is regulated, and then the twist deformation is occurred in the circumferential direction T along the inner wall of the through-hole 13a. Therefore, the total resilient deformation amount of the pair of the resilient contacts 10 of the press-fit terminal 1A is larger than the pair of the resilient contacts 63 of the conventional press-fit terminal being only bent to be resiliently deformed. Further, even if the resilient contacts 10 is formed thick for improving the recovery force, the press-fit terminal 1A can be pressed into the through-hole 13a with relatively low pressure.

As shown in FIG. 13, the pair of the resilient contacts 10 is firmly held at portions 24, 24′, 25, 25′ by the inner wall of the through-hole 13a under recovery force against both bending stress P3, P3′ in the facing direction F and shearing stress P4, P4′ in the circumferential direction T.

Since the recovery force in two directions dispersively urge the inner wall of the through-hole 13a, the pair of the resilient contacts 10 contacts with large contact areas, and troubles such as a seepage of resin from the circuit board 12 or partial detachment of a circuit pattern are prevented. Further, the press-fit terminal 1A is prevented from falling out through the through-hole 13a. Further, a variety in the terminal-holding forces caused by finished dimensions of the through-hole 13a and the press-fit terminal 1 is reduced.

In FIGS. 5 and 13, outer shapes of the resilient contacts 3 or 10 may be so formed as to fit the inner wall of the through-hole 13a without gaps.

According to the embodiments of the present invention, the circuit board 12 having through-holes 13 is used. However, busbars for composing a predetermined circuit pattern in a junction box of a vehicle may be used. The busbars are made from a spotless conductive substrate by a punch press. The busbars are electrically connected to each other by pressing the pair of the resilient contacts 10 of the press-fit terminal 1A into holes of the busbars corresponding to the through-holes 13a.

According to the embodiments of the present invention, in each of the pairs of the resilient contacts 3, 10 of the press-fit terminals 1 and 1A, each resilient contact is supported at both ends thereof, however, may be supported at only one end in the vicinity of the introducing portion 2 as a cantilever.

According to the embodiments of the present invention, each of the circuit board modules 20, 20A includes the direct mounting connector 15, 15′ and the circuit board 12. However, if the number of the press-fit terminals 1, 1A is small, the circuit board module 20, 20A may include only the press-fit terminals 1, 1A and the circuit board 12.

Having now fully described the present invention, it will be apparent to one of ordinary skill in the art that many changes and modifications can be made thereto without departing from the scope of the invention as set forth herein.

1. A press-fit terminal to be pressed into a through-hole of a terminal receiving member for making electrical contact with an inner wall of the through-hole, said press-fit terminal comprising:
a pair of resilient contacts having inner walls on which abutting portions are formed respectively; and
a deformation space into which the resilient contacts are deformed,
whereby the resilient contacts are resiliently deformed in one direction of narrowing the deformation space for abutting and also in direction different from the direction of abutting,
whereby the resilient contacts are pressingly contacted with the inner wall of the through-hole by recovery force of the deformed resilient contacts acting in said two directions.

2. The press-fit terminal as claimed in claim 1,
wherein each of the abutting portions includes an inclined wall by which each of the resilient contacts is caused relative displacement in a direction different from the direction of abutting.

3. The press-fit terminal as claimed in claim 1,
wherein one end of the resilient contacts formed substantially into a V-shape is disposed at a portion where acts as a supporting point for resilient deformation.

4. A circuit board module comprising:
the press-fit terminal as claimed in any one of claims 1 to 3; and
a circuit board having a through-hole for press-fitting and holding the pair of the resilient contacts of the press-fit terminal.

5. The circuit board module as claimed in claim 4,
wherein a connector housing for holding the press-fit terminal is mounted on the circuit board.
